(19) United States
(12) Patent Application Publication
(10) Pub. No.: US 2003/0073372 A1
(43) Pub. Date: Apr. 17, 2003

(54) MANUFACTURING METHOD OF PLASMA DISPLAY PANELS

(76) Inventors: FUMIAKI NAKATAKE, SAITO-SHI (JP); MINORU FUKUI, MIYAZAKI-SHI (JP); YOSHITAKA UKAI, MIYAZAKI-SHI (JP); SHINJI KANAGU, KOBE-SHI (JP); KAZUHIDE IWASAKI, KITAMOROKATA-GUN (JP); AKIHIRO FUJIMOTO, ONO-SHI (JP)

Correspondence Address: STAAS & HALSEY LLP, 700 11TH STREET, NW, SUITE 500, WASHINGTON, DC, 20001, US

(21) Appl. No.: 09/339,199

(22) Filed: Jun. 24, 1999

(30) Foreign Application Priority Data
Jun. 29, 1998 (JP) 10-182178
Jun. 15, 1999 (JP) 11-168418

(51) Int. Cl. H01J 9/26

(52) U.S. Cl. 445/25; 445/40; 445/43

(57) ABSTRACT

In accordance with the present invention, there is provided a method of manufacturing a plasma display panel of the type which includes a discharge space defined between a pair of substrates and sealed by a sealant, the method comprising a first step of forming the sealant on at least one of the substrates and stacking one substrate on the other through the intermediation of the sealant, a second step of reducing the pressure in the space existing between the pair of substrates due to the presence of the sealant and melting the sealant by heating, a third step of curing the sealant to thereby firmly attach the pair of substrates to each other and define a predetermined discharge space, a fourth step of removing impurities in the discharge space, and a fifth step of filling the discharge space with discharge gas.

### BACKGROUND OF THE INVENTION

1. Field of the Invention

This invention relates to a manufacturing method of plasma display panels, referred to hereinafter as PDPs, in which a pair of substrates is vacuum-sealed via discharge space at the periphery, and particularly relates to a sealing method to form the discharge space.

2. Description of the Related Arts

Hereinafter is described a structure of an AC-driven three-electrode surface discharge type PDP as a representative of plasma display panels in which the present invention can be embodied. As shown in FIG. 19, a perspective view partially cutting a PDP, there is arranged for each line L of a display matrix a pair of display electrodes X & Y upon an inner surface of a front glass substrate 50 in order to generate a surface discharge along a surface of the front substrate 50. The display electrodes X & Y may also be called sustain electrodes. The display electrodes X & Y are respectively formed of a stack of a wide straight transparent electrode 52 formed of a thin film of ITO, Indium Tin Oxide, and a narrow straight bus electrode 53 formed of a thin metal film. The display electrodes X & Y are formed by means of a photolithography technique.

Thereupon is provided a dielectric layer 54 for the AC drive, alternating current drive, so as to cover the display electrodes X & Y from the discharge space by means of a screen printing method. Upon dielectric layer 54 is deposited a protecting layer 55 formed of MgO, Magnesium Oxide.

On the other hand, upon an inner surface of a back glass substrate 51 are arranged in order to generate address discharges address electrodes 56 orthogonal to the display electrodes X & Y spaced by a constant pitch. The address electrodes 56 as well are formed with a stack of metal films by means of a photolithography technique.

Upon entire surface of the back glass substrate 51, including the portions above the address electrodes 56, is formed a dielectric layer 57 by means of screen printing method, and further thereupon is provided a plurality of approximately 150 μm high straight separator walls 58 each between adjacent address electrodes 56. Fluorescent materials 60 of three primary colors R (red), G (green) and B (blue) for the full color display are coated so as to cover the surface of dielectric layer 57 including the portions above address electrodes 56 and the sides of separator walls 58 by the means of screen printing method.

Within discharge space 59 is filled a discharge gas, such as typically a mixture of Ne—Xe, i.e. neon gas and xenon gas, of several hundreds torr for exciting the fluorescent materials by irradiating thereon an ultra-violet ray during the discharge. A sealant (seal-grass layer) 61 is provided for sealing the discharge space 59 at the peripheral portions of the substrates.

Front glass substrate 50 and back glass substrate 51 are separately prepared, and finally sealed together with sealant 61 so as to form the discharge space. The structure of the PDP is thus completed now.

Referring to FIGS. 20A, 20B and 21, hereinafter is described a prior art manufacturing method of the PDP including the step to form the discharge space shielded from the external space with the above-described sealant 61. FIGS. 20A and 20B illustrate a cross-sectional cut view and a plan view of PDP in a step for sealing; and FIG. 21 illustrates processing cycles of the heating and the exhausting during the time progress.

Sealant 61 shown in FIGS. 20A and 20Bhas been formed by coating a glass paste on the back glass substrate 51, and next solidifying the paste during preparing the back glass substrate. Thus prepared sealant is melt once during the sealing step and solidified again so as to join front glass substrate 51.

As shown in FIG. 20B, during the prior art sealing process of a PDP 71 front glass substrate and back glass substrate are stacked via sealant 74 and are clamped with many clips 77 at the periphery. Clips 77 are in order to fix both the glass substrates 72 & 73 as well as to impose a predetermined pressure onto the portions to be sealed while the sealant 74 is melted.

That is, in order to form the discharge space 76 during the sealing process using sealant 74 it is necessary to melt by heat the sealant 74 placed between the paired glass substrates 72 & 73 and to deform, i.e. press, the paired glass substrates 72 & 73 so as to have the gap therebetween defined by the height of the separator walls. Accordingly, a pressure has to be imposed in a direction that the paired glass substrates 72 & 73 approach each other. The many clips 77 are needed to generate the pressure.

At the periphery of the back glass substrate 73, a conduction pipe (a glass pipe) 75 is provided so as to make a channel between the discharge space 76 and the outside of the PDP71. The space 76 is exhausted and filled with a discharge gas via the pipe 75. During the prior art sealing process, a pair of the substrates 72 & 73 each of about 3 mm thickness may be damaged by a stress due to direct clamping with many clips 77. Accordingly, it is necessary to seal the pair of substrates 72 & 73 weakly clamped during a long time process.

A prior art method is explained more detail with FIG. 21 showing a processing cycles in above described prior art hereinafter. The pair of substrates 72 & 73 clamped with many clips 77 as shown in FIG. 20B is carried into a furnace (not shown) for heating and then the seal head (not shown) is closely mounted to the pipe 75. The seal head is connected to a pump for exhausting and to gas cylinders which both are not shown in FIG. 20A.

While keeping such the state a heater for heating the furnace is operated first so that the temperature inside the furnace is gradually raised so as to reach a melting temperature of sealant 74. This heating period is illustrated as a temperature-raising period T1. Next, the temperature inside the furnace is kept at the melting temperature of sealant 74 for a predetermined period, which is illustrated as a first temperature-holding period T2. During the temperature holding period T2 sealant 74 is melt so as to allow both the front and back glass substrates to reach to a predetermined gap defined by the height of the separator walls (shown in FIG. 19) by the pressure of clips 77 as shown in FIGS. 20A and 20B.

The first temperature holding period T2 requires a relatively long period because the process during temperature holding period T2 has to be carried out while the substrates 72 & 73 are clamped with clips having week pressure as described above. When the gap between front glass substrate 72 and back glass substrate 73 reaches the predetermined gap defined by the separator walls the temperature inside the furnace is decreased down to a solidifying temperature of sealant 74. This period is illustrated as a temperature-lowering period T3. During these periods to T3 no exhausting nor gas-filling is carried out from/into a discharge space 76 formed by the sealing process.

Next, thus lowered temperature during the temperature lowering period T3 is held for a predetermined period, a second temperature holding period T4. This temperature is a relatively high level such that sealant 74 does not melt. Upon beginning the second temperature-holding period T4, discharge space 76 is exhausted via an exhausting tube 75. This exhausting process is carried out in order to remove impurities existing in discharge space 76; accordingly the temperature is kept at the high temperature T4 of second temperature holding period T4 so high as to drive out impurity gases adsorbed by the dielectric layers and the protection layers. The second temperature-holding period T4 is chosen according to the period required for the impurity gases to finish removing.

Next, the temperature inside the furnace is lowered by terminating the heater as illustrated as a second temperature lowering period T5, during which the exhausting operation is kept on so as to further remove the impurities. Upon completion of the impurity removal from the discharge space 76 and stabilization of the temperature inside the furnace at a room temperature as illustrated as a room temperature period T6, a discharge gas is introduced, instead of the exhausting, via the conduction pipe 75 by switching a valve (not shown) provided on a pipe connected to the conduction pipe. The discharge gas is typically a mixture of neon gas and xenon gas.

By completing the processing cycle described above, the front glass substrate 72 and the back glass substrate 73 are sealed together by the sealant so as to form discharge space 76 between these substrates 72 & 73.

In the above described prior art method, there is a possibility of breaking glass substrates 72 & 73 due to the stress caused from many clips 77 directly contacting glass substrates 72 & 73. Therefore, the sealing process is carried out spending a relatively long period with a weak clipping pressure.

Accordingly, a long period is required for the first temperature-holding period T2, that is a sealing process, resulting in the lowering of the process efficiency. Non uniformity of the clip pressure may cause a local stress or cause an insufficiently pressed portion, whereby the glass substrate may be broken or may be incompletely sealed.

The impurity removal from the discharge space via the conduction pipe 75 only also may cause a long exhausting period and insufficient purity in the discharge space.

### SUMMARY OF THE INVENTION

It is a general object of the invention to provide a manufacturing method of plasma display panel which is suitable for a high efficient mass production and includes a process for reliable sealing and impurity removal of/from the space formed between a pair of substrates.

The present invention provides a manufacturing method of plasma display panel based on a point that sealing a periphery of the pair of substrates is carried with use of a force caused by a pressure difference between an in- and out-side of the pair during a sealant melting. To be more concrete, the present invention provides the manufacturing method of plasma display panel which comprises sequentially a first step of forming the sealant in a frame-shape on a periphery of at least one of the substrates and stacking one of substrates onto the another via the sealant, a second step of lowering the pressure in the space closed with the sealant between the pair and of heating the sealant for melting so as to press the sealant and define a gap between the substrates, a third step of curing the sealant once in being melted to glue and fix firmly the pair to each other and form a discharge space between the pair of the substrates, and a fourth step of removing impurities out of the discharge space.

In the method according to the present invention described above, the pair is pressed toward each other, pressing the sealant by the force due to the pressure difference between the outside and inside of the pair during the sealant being melted by heating. Accordingly the external force applied to the pair may be minimized, a local stress caused in the prior art is decreased and the period for sealing the pair may be shorten in the method of the present invention. The present invention is also desirable for the high efficient mass-production of the panels owing to applying the method to a sealing process in the production process where a plurality of plasma display panels is cut out from a single pair of large substrates.

And still more, the present invention provides a manufacturing method based on a point that the gap of the discharge space in the three-electrodes surface discharge type PDP described above is kept by a plurality of separator walls or ribs for separating the discharge space formed in predetermined pattern on the inner surface of substrate. The method for sealing at the periphery of the pair of substrates at interval due to the height of the walls includes a step for forming previously on one of substrates a sealant in a frame-shape higher than that of the walls and for setting an assembly of the pair of substrates in a furnace able to heat and exhaust therein, and for exhausting the outside of the pair and in turn as well the inside during the sealant being melted

Owing to the above described invention, the present invention may improve the dynamic and/or display characteristics, because exhausting the residual solid and/or gaseous impurities in the discharge space via a leak-gap at a contact-portion of the sealant and the substrate is available in a period till the beginning of the sealant-melting.

The invention described above improves color purity of light emitted from fluorescent material, which is formed on one of the pair, particularly on the back substrate, as well as the separator walls in the plasma display panels subject to the present invention, because heating to melt the sealant is carried out in forming a vacuum and also sufficient purification due to the use of pressure difference between in- and out-side of the pair is completed. On the other hand the luminous characteristics, such as a color temperature, in plasma display panels produced via a prior art manufacturing method is poor due to a damage caused in a process in the method.

The above-mentioned features and advantages of the present invention, together with other objects and advantages, which will become apparent, will be more fully described hereinafter, with references being made to the accompanying drawings which form a part hereof, wherein like numerals refer to like parts throughout.

### A BRIEF DESCRIPTION OF THE DRAWINGS

FIG. 1 is a chart schematically illustrating basic processing cycles for time elapsed of the present invention;

FIG. 2A schematically illustrates a cross sectional view of a PDP at a sealing step of the present invention;

FIG. 2B schematically illustrates a plane view of a PDP at a sealing step of the present invention;

FIG. 3A schematically illustrates a cross-sectional view of a PDP before stacking substrates together of the first preferred embodiment of the present invention;

FIG. 3B schematically illustrates a cross-sectional view of a PDP shown in FIG. 3A at stacking substrates together;

FIG. 3C schematically illustrates a cross-sectional view of a PDP after sealing a pair of the substrates shown in FIG. 3A;

FIG. 4 schematically illustrates a perspective view of a back glass substrate in the first preferred embodiment of the present invention;

FIG. 5 schematically illustrates a temperature profile and a pressure profile in processing cycles of a sealing process in the first preferred embodiment of the present invention;

FIG. 6 schematically illustrates a plane view of a modified back glass panel in the first preferred embodiment of the present invention;

FIG. 7A schematically illustrates a plane view of a PDP in a second preferred embodiment of the present invention;

FIG. 7B schematically illustrates a cross-sectional view of the PDP shown in FIG. 7A;

FIG. 8A schematically illustrates a plane view of a PDP in a third preferred embodiment of the present invention;

FIG. 8B schematically illustrates a cross-sectional view of the PDP shown in FIG. 8A;

FIG. 9 schematically illustrates a temperature profile and a pressure profile in processing cycles of a sealing process in the fourth preferred embodiment of the present invention;

FIG. 10 schematically illustrates a cross-sectional view of a PDP in sealing process of a fifth preferred embodiment of the present invention;

FIG. 11 schematically illustrates a cross-sectional view of the PDP shown in FIG. 10;

FIG. 12 schematically illustrates a temperature profile in a processing cycle of a sealing process in the fifth preferred embodiment of the present invention;

FIG. 13 schematically illustrates a cross-sectional view of a PDP in sealing process of a sixth preferred embodiment of the present invention;

FIG. 14 schematically illustrates a temperature profile in processing cycles of a sealing process in the sixth preferred embodiment;

FIG. 15 schematically illustrates a cross-sectional view of a PDP in sealing process of a seventh preferred embodiment of the present invention;

FIG. 16 schematically illustrates a temperature profile in processing cycles of a sealing process in the seventh preferred embodiment of the present invention;

FIG. 17 schematically illustrates a perspective view of a seal-head using in the sixth preferred embodiment;

FIG. 18 schematically illustrates operations of the seal-head shown in FIG. 17;

FIG. 19 schematically illustrates a perspective view of partially cutting a PDP;

FIG. 20A schematically illustrates a cross-sectional view of a PDP in a prior art;

FIG. 20B schematically illustrates a plane view of the PDP shown in FIG. 20A; and

FIG. 21 schematically illustrates a temperature profile in a processing cycle of a sealing process of a prior art shown in FIGS. 20A and 20B.

### DESCRIPTION OF THE PREFERRED EMBODIMENT

With reference to drawings preferred embodiments of the present invention are hereinafter described in detail.

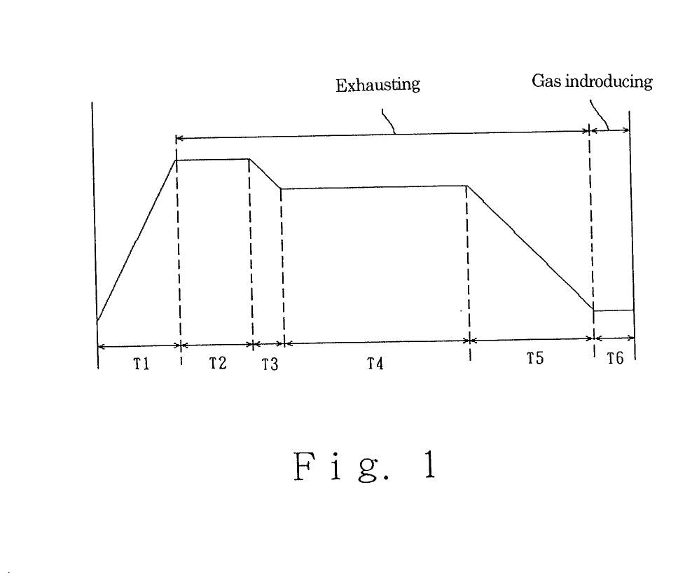

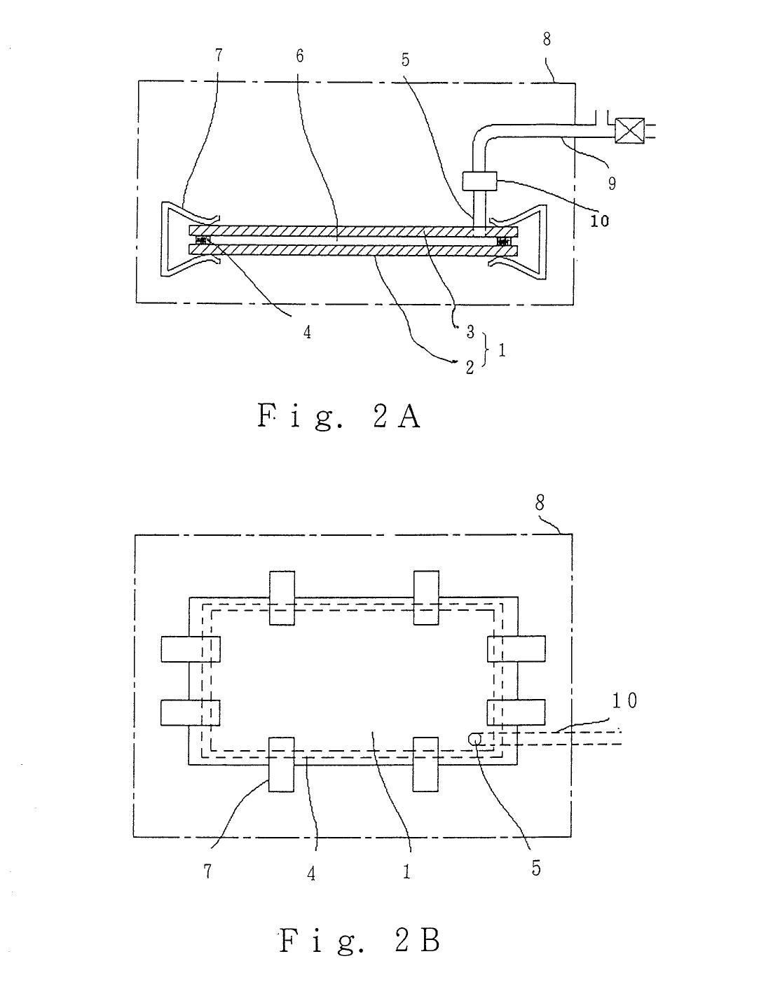

FIG. 1 is a chart schematically illustrating basic processing cycles for the time elapsed. FIGS. 2A and 2B schematically illustrate a state of a PDP at a sealing step according to the method of the present invention.

First of all, the principle of the present invention is hereinafter described referring to FIG. 1 and FIGS. 2A and 2B.

According to the present invention, a pressure to press a sealant (a seal-glass layer) to be melted during the sealing process is supplied by generating a pressure difference between the inside of the paired glass substrates and the outside thereof. That is, the pressure inside the discharge space is kept low by exhausting the discharge space so that the sealant is pressed by the pressure caused by the exhausting in a direction for the substrates to approach each other.

Accordingly, the many previously employed clips for applying the weak pressure are no more necessary, but only a few clips for preventing a positional displacement of the substrate can tentatively fix the substrates for the sealing process.

FIGS. 2A and 2B illustrate a cross-sectional cut view and a plan view of the state of PDP in this sealing process.

A PDP 1 according to the present invention is formed of a front glass substrate 2 and a back glass substrate 3, which are pinched with each other with clips 7 while a sealant 4 in a shape of a frame is placed therebetween at the peripheries. Upon inner surfaces of front glass substrate 2 and back glass substrate 3 are formed electrodes, dielectric layer and separator walls, however, which are not illustrated in FIGS. 2A and 2B to simplify the drawings.

It should be noted that as apparent from FIG. 2B the clips 7 are provided so few as to adequately prevent a mutual deviation of the substrates, and require less pinching pressure than that of the prior arts.

PDP 1 is placed in the furnace 8 so as to be processed for the heating, the exhausting and gas introduction. In a practical furnace 8, though not illustrated in the drawings, are provide plural shelves to carry the plural PDPs 1 aligning horizontally as well as vertically so as to be processed at the same time according to the hereinafter described processing cycles shown in FIG. 1.

As shown in FIG. 1, the temperature inside the furnace 8 gradually is raised until reaching a melting temperature of sealant 4 (seal-glass layer) through a temperature-raising period T1. Then, the temperature inside the furnace 8 is held for a predetermined period, a temperature holding period T2. At this temperature holding period T2 is started the exhausting operation via pipe 5.

As the sealant (seal-glass layer) 4 which has been prepared in a solidified state on the substrate is melt and able to be adhesive during temperature holding period T2, a gap between the sealant and the substrate vanishes and an exhausting operation via the pipe lowers the pressure inside the discharge space 6 causes an external pressure in a direction to press the substrates 2 & 3 toward each other so that melted sealant 4 is pressed to be deformed so as to make the height of the discharge space 6 the predetermined gap defined by the separator walls.

When the gap between the paired glass substrates 2 & 3 becomes the predetermined value the temperature inside the furnace 8 is lowered to a temperature of the solidifying temperature of sealant 4 during a temperature lowering period T3, during which as well the exhausting operation is still continuously kept on.

Next, the temperature lowered during temperature lowering period T3 is held for a predetermined period called a temperature-holding period T4. This temperature is set relatively high but of such a level that the sealant does not melt. During temperature holding period T4 as well the exhausting process is kept on.

The exhausting operation during and after the temperature lowering period T3 is in order to remove the impurities existing in discharge space 6; accordingly, there is provided temperature holding period T4 for keeping such the relatively high temperature that the removal of the impurity gas (hydrocarbon and so on) and moisture adsorbed in the dielectric layer or the protection layer can be accelerated at a high temperature.

Temperature holding period T4 is determined according to a period by which the impurity gases are removed from the protection layer, etc. becomes so little as to give no effect onto the characteristics of the PDP. Next, the heater of the furnace is shut down so as to lower the temperature inside the furnace 8 for temperature lowering period T5, during which the exhausting operation is kept on so as to remove further the impurities.

When the impurities within discharge space 6 is removed and the temperature inside the furnace 8 is stabilized, which is called a room temperature period T6, in stead of the exhausting operation a discharge gas is introduced into the discharge space via pipe 5. The discharge gas is typically a mixture of neon gas and xenon gas, and can be introduced by opening the valve provided to pipe 9, and by shutting the exhaust valve and shutting down the exhaust pump.

Next, without breaking the vacuum inside the discharge space 6, the conduction pipe pipe 5 is removed and the through hole provided for the conduction pipe on the back glass substrate 3 is closed so as to complete the PDP 1.

According to the above described processing cycles of the present invention the sealant 4 can be pressed to deform by adjusting the internal pressure of the discharge space without imposing an external pressure directly onto the substrates 2 & 3. No stress directly contacting the glass substrates allows such a short sealing period owing to a rapid exhausting process lowering the inside pressure down to a predetermined value. Further, the exhaustion can remove the impurity from the discharge space.

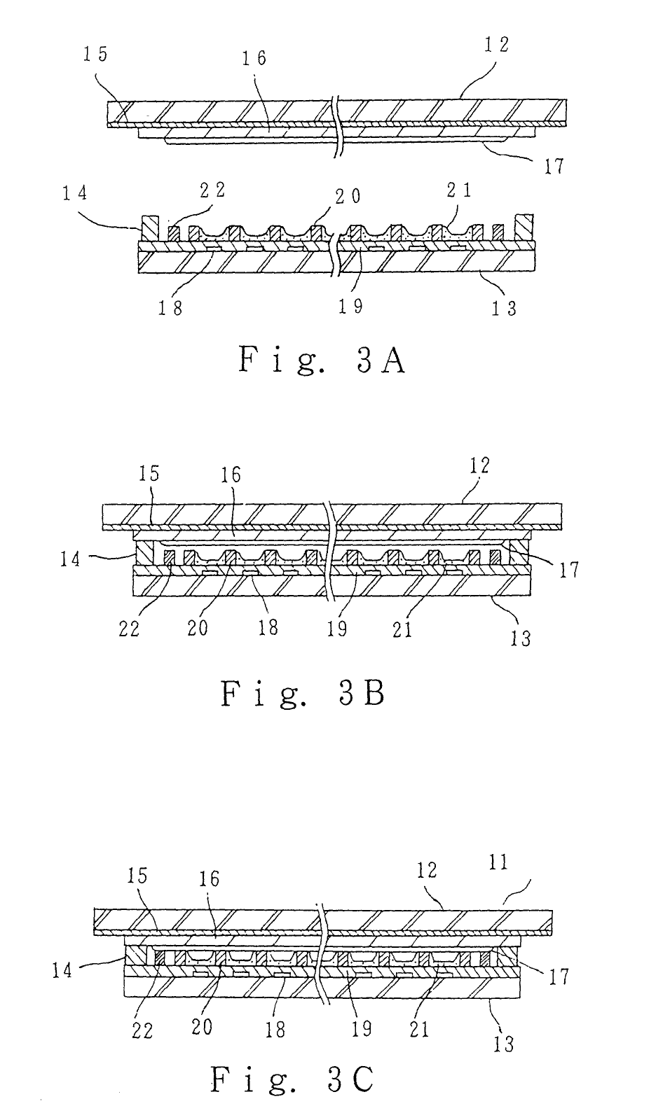

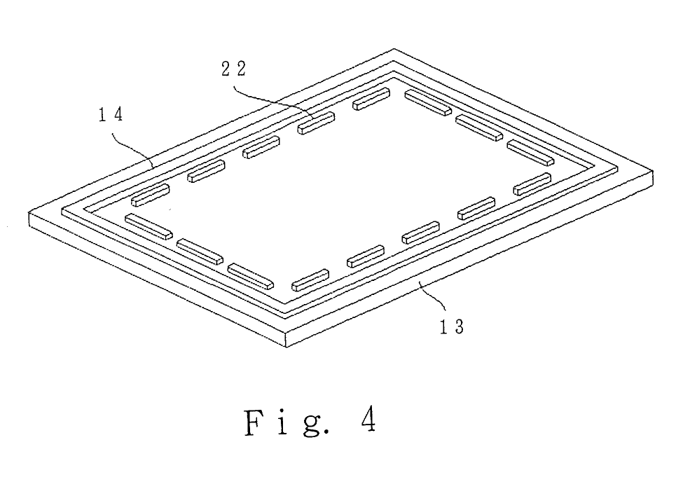

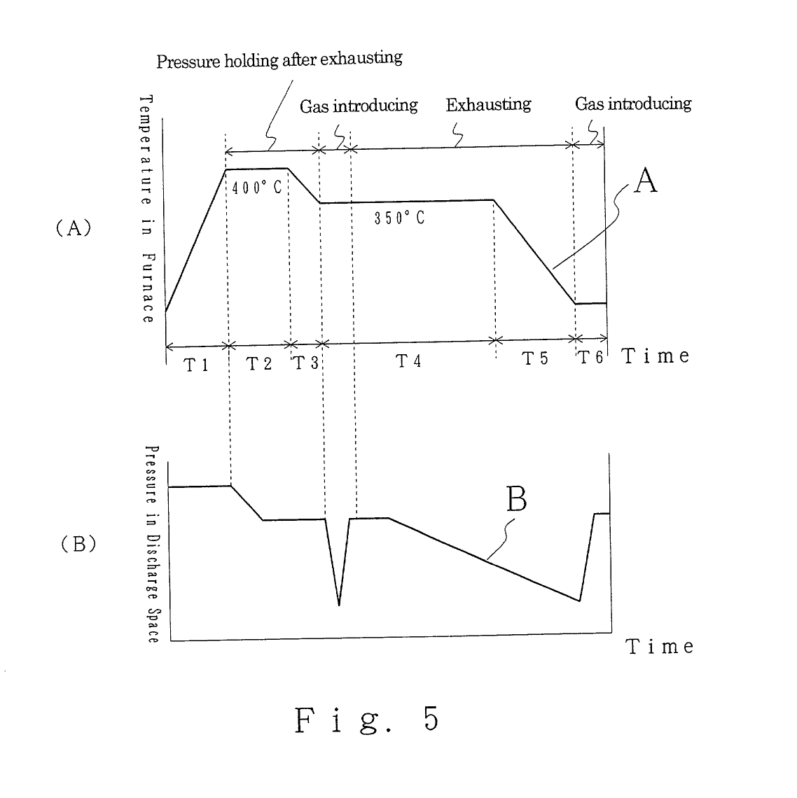

FIGS. 3A, 3B, 3C, 4, and 5 describe the first preferred embodiment of the present invention. FIGS. 3A, 3B and 3C are cross-sectional cut views schematically illustrating the internal of PDP on the processes until sealed. FIG. 4 is a perspective view of the back glass substrate on which the sealant is formed. FIGS. 5 schematically illustrates processing cycles.

Upon front glass substrate 12 have been formed display electrodes 15, dielectric layer 16 and protection layer 17 as shown in FIG. 3A. Upon back glass substrate 13 have been formed address electrodes 18, dielectric layer 19, separator walls 20 for defining discharge space & discharge gap and fluorescent material 21 placed between separator walls 20, sealant 14 and barrier walls 22 for preventing an inward invasion of sealant 14.

The panel constructional components such as electrodes, dielectric layer, separator walls and fluorescent material are formed by the use of general processes, such as photolithography and screen printing.

The perspective view FIG. 4 illustrates more clearly the construction of sealant 14 and barrier walls 22. Sealant (seal-glass layer) 14 is formed in a shape of a frame on the peripheries of back substrate 13. Barrier walls 22 are formed intermittent via predetermined openings—on a little inner side of sealant 14 spaced therefrom by a clearance—. Barrier walls 22 are for preventing an invasion of sealant 14 into the display area when the discharge space is exhausted. Openings between adjacent barrier walls are for providing exhaustion paths.

The address electrodes and dielectric layer are omitted from FIG. 4 in order to simplify the description, but only sealant 14 and barrier walls 22 are drawn therein.

The front and back glass substrates 12, 13 are stacked so as to form the state illustrated in FIG. 3B. In order to prevent the substrate deviation thus stacked substrate pair is fixed with clips having so weak a spring force as to give substantially no stress onto the substrates. At this state, there is a clearance between the separator walls 20 and the front substrate 12, in a strict meaning the protection film 17, because the front substrate 12 is supported by the sealant 14 formed on the back substrate 13 as apparently seen in FIG. 3B. Further, there are provided gaps between the sealant 14 and the substrate because a top-portion of the sealant 14 is not entirely flat.

Thus tentatively fixed substrate pair 12 & 13 is carried into the furnace so as to start the heating and exhausting process. The state in the furnace is shown in FIGS. 2A and 2B.

FIGS. 5 show a temperature and pressure profiles of a processing cycle by “A” and “B” respectively.

Within the furnace the temperature is gradually raised by switching the heater on for temperature raising period T1 up typically 400° C. as shown in the processing cycles by the profile A in FIG. 5 because the sealant 14 employed in the preferred embodiment is formed mainly of a low melting temperature glass of typically 400° C.

The furnace temperature reaching to 400° C. causes the sealant melting and then the top of the sealant 14 is glued to the substrate. So the gap between the sealant and the substrate vanishes. Accordingly the gap (discharge space) between the front and back substrates 12 & 13 becomes in airtight.

Next, the temperature 400° C. to melt the sealant is held for a predetermined period, i.e. temperature holding period T2.

During temperature holding period T2 the exhausting operation is started as shown in FIG. 5 so as to make the internal pressure the predetermined lowered pressure, typically about 50,000˜70,000 Pa (pascal). This internal pressure is necessary for deforming the sealant 14 so as to pull front glass substrate 12 and back glass substrate 13 toward each other, and is appropriately determined accordingly to the material of sealant 14 and the volume of the discharge space, etc.

When the internal pressure of the discharge space becomes the desired pressure (50,000˜70,000 Pa), the exhaust operation is once terminated so as to hold the pressure. At this time, owing to the sealant being melted and the lowered internal pressure the front glass substrate 12 and the back glass substrate 13 are pulled to each other while pushing the sealant 14. While once terminating of the exhaust prevents the melting sealant from flowing into discharge space.

After the predetermined period has elapsed, the front and back glass substrate 12 & 13 are pulled to reach the position supported with separator walls 20 as shown in FIG. 3C. In the first preferred embodiment temperature-holding period T2 is typically set at 10 minutes, which could adequately provide the desired discharge space.

Next, the temperature inside the furnace is lowered down to the solidifying temperature of sealant 14 during temperature lowering period T3, so as to finish the sealing operation with sealant 14. Next, the temperature lowered during temperature lowering period T3 is held for a predetermine period, temperature holding period T4. This temperature is set at typically 350° C., which relatively high but of a level which does not melt the sealant 14.

During a first half of temperature holding period T4 the exhaust is begun again till the inner pressure reaches to around 10 Pa. And then a mixture of Neon and Xenon gas for the discharge is introduced via the pipe to the discharge space, and then exhausting operation is started out again. The gas introduction now carried out is for wash out the impurities inside the discharge space. The introduction of the discharge gas into all the corners of the discharge space and re-exhaustion thereof allow more certain removal of the impurities.

A continuation of temperature holding period T4 then after for a predetermined period is to accelerate the impurity gas generation from the dielectric layer 16 and 19 and protection layer 17, etc..

Furthermore, during the exhausting period immediately after temperature holding period T4 a gas aging operation is carried out by applying a predetermined voltage onto the address electrode. This aging process is to stabilize the address electrodes.

Temperature holding period T4 set according to a period during which the gas generation from the panel constructual component is no more observed. Next, the temperature inside the furnace is lowered during temperature lowering period T5 by terminating the operation of the heater. During this period as well the exhaust is carried out so as to remove further the impurities.

When the impurities in the discharge space is removed and the temperature inside the furnace is stabilized at the room temperature as shown with a room temperature period T6, the discharge gas, i.e. the mixture of neon and xenon gases is introduced in place of the exhaust via the pipe.

After finishing these processes the glass substrate pair 12 & 13 is stacked each other so as to form desired discharge space defined with separator walls therebetween and the discharge gas is introduced into the discharge space.

According to the first preferred embodiment it is possible to shorten the sealing step, i.e. temperature holding period T2, which costed several hours in the prior art method down to several tens minutes. Furthermore, less labor required to fix the many clips improves the production efficiency.

Further more the thickness of the sealed portions were measured at several points of the PDP produced in the first preferred embodiment, it was found that the measured values were substantially equal to the specified values; accordingly, desired sealing was completed.

Moreover, the brightness and the color purity of the PDP were improved comparing with the case prior art employing clip pressure. And the color temperature was improved around 20% up and the current values were also stable. These improvements probably were owing to precisely formed discharge space, sufficient exhaust of impurity and avoidance of a process in air at high temperature.

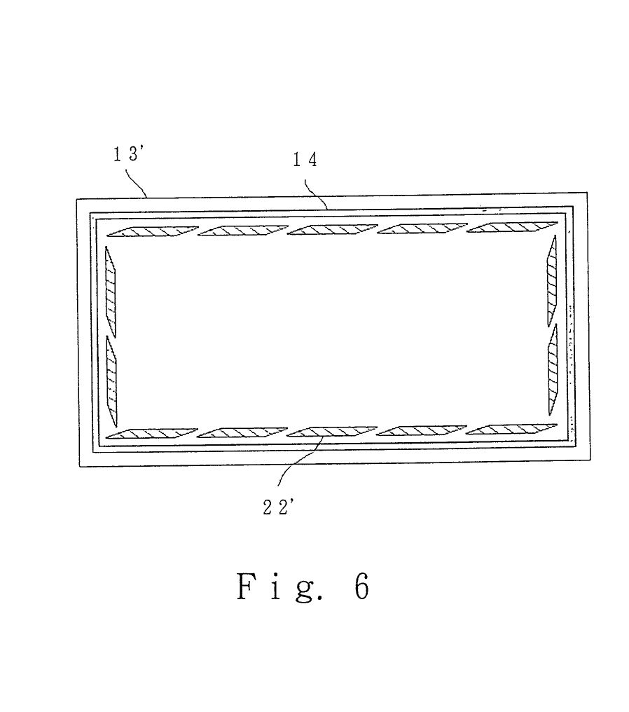

As shown in FIG. 6, inside a sealant of back glass substrate 13′ are provided protection walls having exhaust paths extending along a slanted direction with respect to the sealant 14. Such a shape of protection walls 22′ allows sure portion of sealant 14 while exhausting paths are secured.

The protection walls 22′ of the first preferred embodiment is in order to protect the melted sealant during exhausting the discharge space: from the it's invasion into the display area; however proper selection of the exhausting pressure and exhausting period allows to hold substrate's position without pulling in the sealant. Accordingly the protection wall are not always necessary.

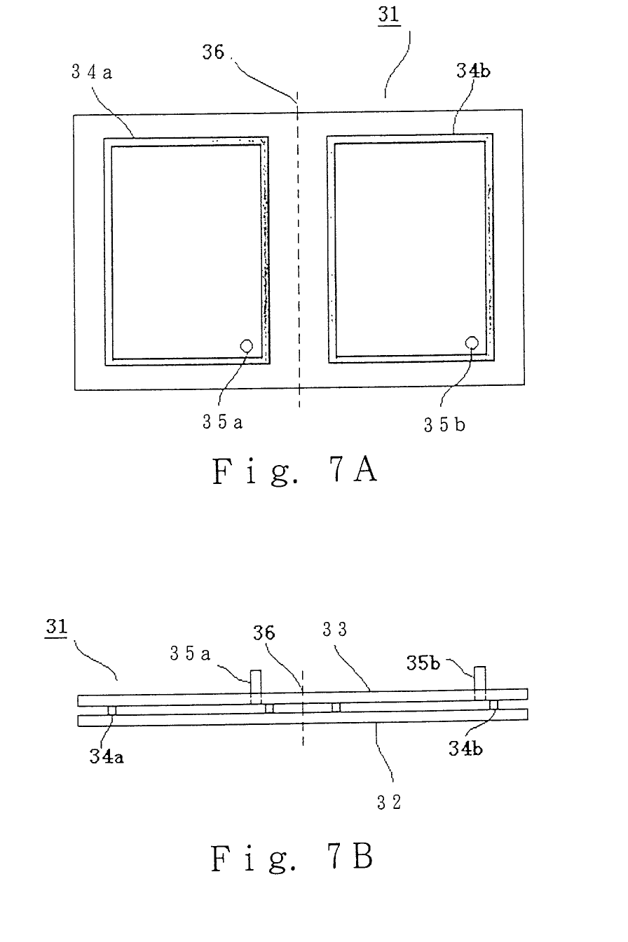

FIG. 7 shows a PDP according to the second embodiment of the present invention. FIG. 7A is a plan view, and FIG. 7B is a sectional view. In this embodiment, a plurality of panels are simultaneously formed, which makes the present invention particularly suitable.

To effect mass production efficiently, a method has come to be adopted in which a plurality of PDP panel substrates are obtained from a single glass substrate (a pair of opposing substrates). In this method, the components of a plurality of panels, such as electrodes, dielectric layers, and separator walls, which are for a plurality of PDP, are simultaneously formed on a large glass substrate. Then, the large glass substrate is cut and divided into individual panels, whereby a plurality of PDPs are finally obtained, thereby achieving an improvement in terms of production efficiency.

In a PDP 31 shown in FIG. 7 (Here, what is composed of two PDPs is also referred to as a “PDP”), the patterns of the electrodes, dielectric layers, etc. are changed as described above to thereby form two PDPs simultaneously.

Between a front glass substrate 32 and a back glass substrate 33, which are large enough to be formed into two PDPs, there are arranged two frame-like sealants 34a and 34b side by side. Further, the back glass substrate 33 has two conduction pipes 35a and 35b which are in the areas surrounded by the sealants 34a and 34b, respectively.

Unlike the case in which only one PDP is formed from a single substrate and in which the sealant is formed only in the peripheral portion of the substrate, when two sealants 34a and 34b are thus formed, the sealants are arranged also in the central portion of the glass substrate. Thus, in the conventional technique, in which the sealant is pressurized by a clip, the portion of the sealant in the central portion of the substrate cannot be pressurized. In view of this, it is necessary to provide a jig (large clip or the like) for pressurizing the portion of the sealant material in the central portion of the glass substrate from above and below, with the result that the device becomes rather large.

In the present invention, in contrast, the pressurizing force to be applied to the sealant material is obtained by reducing the pressure in the discharge space, so that no such clip (including a large clip) is needed. Thus, even in the case in which the sealant material exists in the central portion of the glass substrate as in this embodiment, the sealing can be effected easily and reliably.

The PDP 31 shown in FIGS. 7A and 7B is put in a heating furnace in this condition, and undergoes sealing and exhausting processes.

In the heating furnace, different seal heads are attached to the conduction pipes 35a and 35b and the exhaust of the discharge spaces and the introduction of discharge gas are effected through different piping systems.

The processing cycle after this is the same as that of the first embodiment shown in FIGS. 5A and 5B, so a description thereof will be omitted. After this processing cycle, as in the first embodiment, discharge gas is introduced and the conduction pipes 35a and 35b are removed. Then, the PDP 31 is taken out of the heating furnace, and the front glass substrate 32 and the back glass substrate 33 are cut along the central cutting line 36, thereby completing two PDPs simultaneously.

In this embodiment, described above, when forming two PDPs simultaneously in order to enhance mass productivity, it is possible to reliably effect the sealing without having to apply pressure from outside to the central portion of the glass.

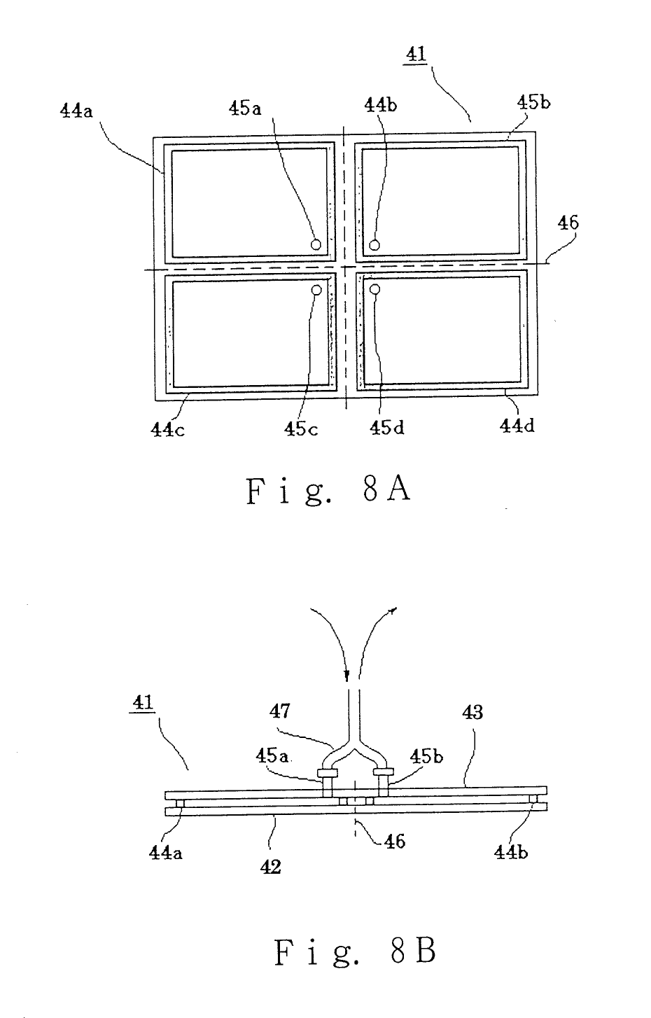

FIGS. 8A and 8B show a PDP according to the third embodiment of the present invention. FIG. 8A is a plan view, and FIG. 8B is a sectional view. In this embodiment, to further enhance mass productivity as compared to the second embodiment, four PDPs are simultaneously formed.

In a PDP 41 shown in FIGS. 8A and 8B (Here, what is comprised of four PDPs is also referred to as a “PDP”), the patterns of the electrodes, dielectric layers, etc. are changed as described above, whereby four PDPs are simultaneously formed.

In this embodiment, a large glass substrate is divided into four areas by cutting lines, and frame-shape sealants 44a, 44b, 44c and 44d are respectively arranged in the four areas. Further, four conduction pipes 45a, 45b, 45c and 45d are respectively arranged in the areas surrounded by the sealants.

The four conductionpipes 45a, 45b, 45c, and 45d are provided in the portions of the back glass substrate 43 which correspond to the central portion of the substrate where the four areas are adjacent to each other, whereby it is possible to effect the exhaustion and the introduction of discharge gas simultaneously through a common piping.

As shown in FIG. 8B, in the heating furnace, the four conduction pipes 45a, 45b, 45c, and 45d of the PDP 41 of this embodiment are connected to a single piping 47 through seal heads. Thus, when the exhaustion and the introduction of discharge gas are effected through the piping 47 as indicated by arrows, processing is simultaneously effected in the individually formed discharge spaces.

The processing of the PDP 41 put in the heating furnace is the same as that of the first embodiment shown in FIG. 5A and 5B, so a description thereof will be omitted. Since the pressure of the discharge spaces is reduced with the sealants 44a, 44b, 44c, 44d being melted, it is possible to easily perform sealing without applying pressure from outside.

As in the second embodiment, in this embodiment, the sealant are arranged also in an area (central portion) other than the peripheral portion of the glass substrate. However, as described above, the sealing is effected by obtaining the pressure for pressurizing the sealants by reducing the pressure in the discharge spaces, so that the sealing of the central portion can be reliably effected.

After thus effecting the sealing, the removal of impurities in the discharge spaces and the introduction of discharge gas are effected and, further, the conduction pipes 45a, 45b, 45c, and 45d are removed. After this, the PDP 41 is taken out of the heating furnace, and the front glass substrate 42 and the back glass substrate 43 are cut along the cutting lines 46, whereby four PDPs are simultaneously completed.

In this embodiment, described above, when forming four PDPs simultaneously to enhance mass productivity, it is possible to reliably effect the sealing of the central glass portion without applying pressure from outside.

Further, since the conduction pipes 45a, 45b, 45c, and 45d are provided close to each other in the central portion of the back glass substrate 43, and the exhaustion and the introduction of discharge gas is effected through the common piping 47, the construction of the exhaust system is simplified, and the control thereof is facilitated.

In the embodiment described above, the gas is introduced into the discharge space as to remove the impurities out of the space during the temperature-holding period T4. The effect similar to that in the embodiment described above is obtained in the process in which the temperrature holding period T2 shown in FIG. 5 is set longer, and a discharge gas, N2 gas, or Ar gas is introduced into the space after ten minutes after the begining of the T2, and then the exhaust of the space is begun again.

In the embodiment described above, the exhaust is begun when the inner temperature of the furnace reaches around the temperature of the sealant melting. The exhaust may be begun in the state in which the temperature is lower than the temperature of the sealant melting.

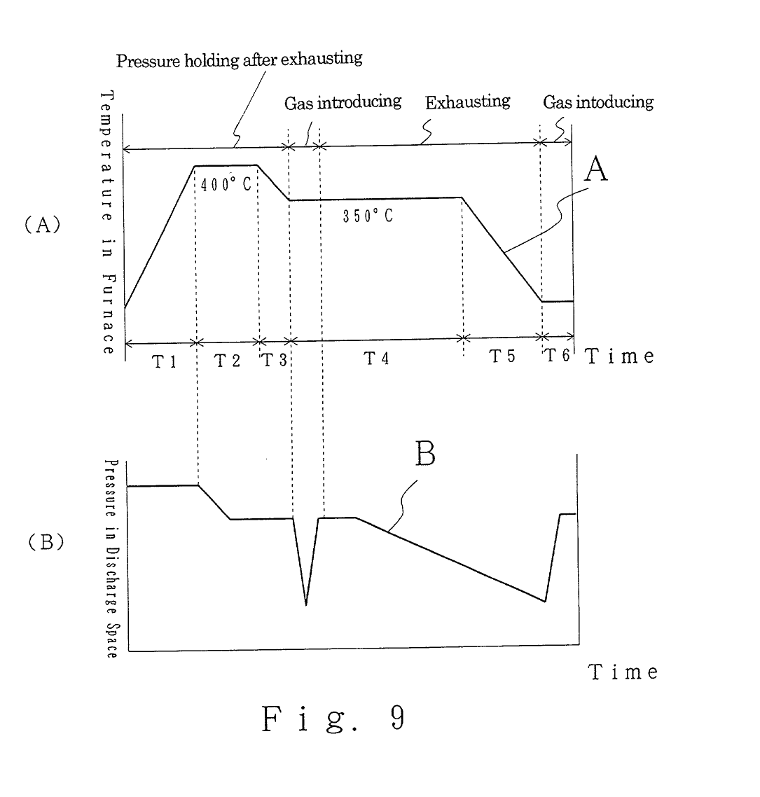

The fourth embodiment is an example in which the beginning of the exhaust is in synchronous with the beginning of the heating process in the furnace. The profiles of temperature and pressure in the fourth preferred embodiment are shown by “A” and “B” in FIG. 9 respectively. In the embodiment, the exhaust is begun at the beginning of the temperature raising period T1 in FIG. 9 and terminated once with half of the temperature holding period T2. As shown by the profile B in FIG. 9, owing to simultaneous beginning of the temperature raising and the exhaust via the conduction pipe, the pressure in the discharge space is held to around the beginning of the temperature holding period T2 and decreases after the furnace temperature reaching to 400° C.

The pressure, that is, does not change during the temperature in the furnace is below the sealant melting temperature, because a gas (air) in the furnace is inhaled into the discharge space via a gap between an un-melt sealant and the front glass substrate. That is, the heated-air-flow ambient the pair of the substrates is introduced into the discharge space and sent out from the space via the conduction pipe. The heated-air-flow removes the impurity, such as hydrocarbon, etc. to the exterior of the pair. Accordingly, the removal of the impurity from the discharge space is more effectively.

Then after reaching of the temperature in furnace to the sealant melting temperature, the pressure in the discharge space is decreased by exhausting and kept by terminating the exhaust owing to the discharge space being in airtight by vanishing of the gap by the sealant melting and stacking to the substrate.

In the fourth embodiment, as the exhaust is begun before the sealant melting and the heated-air-flow removes the impurity in the space, the removal of the impurity from the space is more effectively. It is preferable to fill the furnace with N2 gas, etc. to improve the effect of purification in the discharge space.

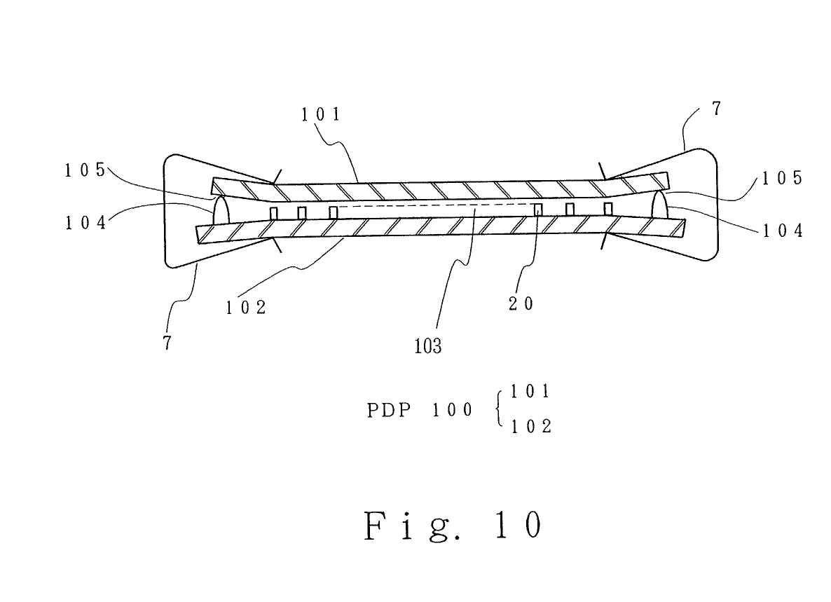

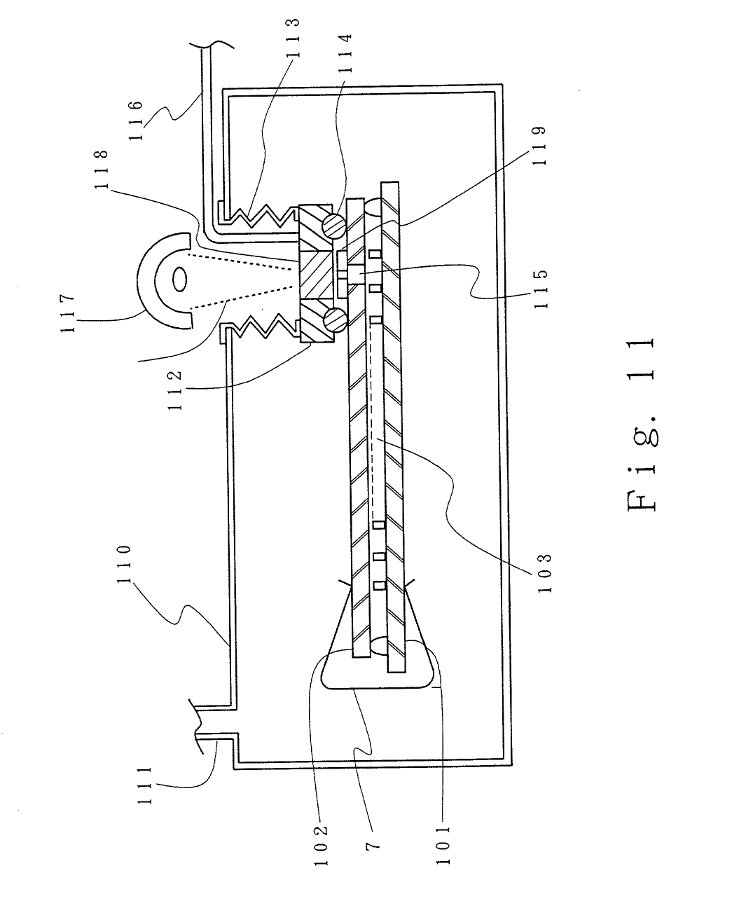

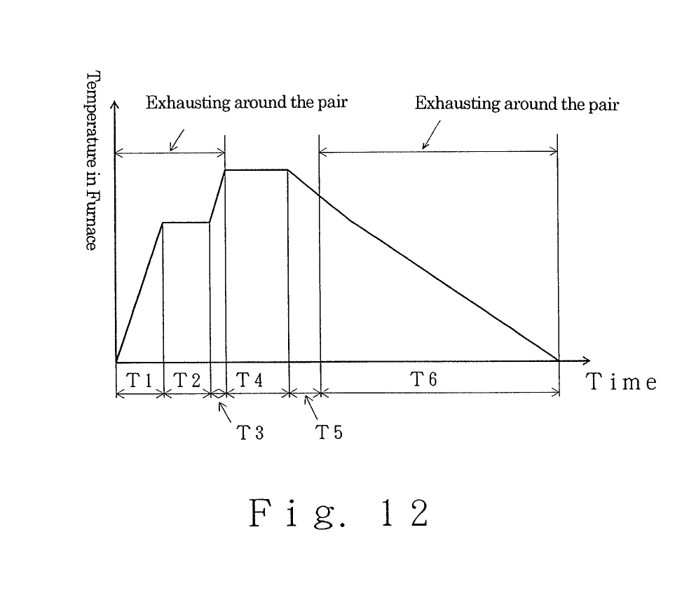

FIGS. 10 through 12 illustrate the fifth embodiment of the present invention. FIG. 10 is a sectional view showing a pair of glass substrates 101 and 102 superimposed one upon the other, FIG. 11 illustrates the sealing process with the pair of substrates 101 and 102, and FIG. 12 illustrates a processing cycle. As in the first embodiment, various electrodes, dielectric layer, protective layer, separator walls, fluorescent substance, etc. are arranged on the front glass substrate 101 and the back glass substrate 102.

The fifth preferred embodiment is different from the first to the fourth embodiment in that, the gaseous impurity in the discharge space is exhausted via gap, which is formed between the sealant and the substrate, during the sealant in unmelting.

The front glass substrate 101 and the back glass substrate 102 are stacked together, and are secured in position by a plurality of clips 7 formed of a heat resistant and elastic material such as an alloy of iron, nickel, chrome and molybdenum. The clips 7 are mounted at positions near the separator walls 20 in close proximity to sealant 104 of a discharge space 103 defined by the front glass substrate 101 and the back glass substrate 102. The clamping force of the clips 7 is adjusted such that the top portion of the separator walls 20 is in close contact with an MgO protective layer (not shown) of the front glass substrate 101. This adjustment of the clamping force may be effected by selecting the most preferable ones from clips 7 of various levels of clamping force prepared in advance. Here, the stacking together of the front glass substrate 101 and the back glass substrate 102 is completed. What is important in this process is that the top portions of the sealant 104 between the front glass substrate 101 and the back glass substrate 102 stacked together is such that there is a gap 105 which allows free movement of gas due to slight variation in the formation of the sealant material 104 and warpage of the glass substrates 101 and 102.

A shaped frit glass 119 formed in advance is arranged in a through-hole 115 of the pair of substrates 101 and 102 stacked together (hereinafter referred to as “PDP 100”) (See FIG. 11). This shaped frit glass 119 is secured to the back glass substrate 102 by a resin which decomposes by low-temperature heating such that it does not move when the PDP 100 is transferred.

Next, this PDP 100 is put in a vacuum heating furnace 110 capable of evacuation while being heated. This vacuum heating furnace 110 is heated by a heater (not shown), and the interior of the furnace can be evacuated by a vacuum pump (not shown) connected thereto by way of an outlet 111, creating a high vacuum state in the furnace. Further, as described below, an ascent/descent type seal head 112 for effecting the exhaust of the discharge space 103 only and the filling of the discharge space 103 with discharge gas, is provided in the vacuum heating furnace 110 through the intermediation of a bellows 113.

In this vacuum heating furnace 110, the PDP 100 undergoes the processing cycle shown in FIG. 12. Simultaneously with the starting of the heating of the vacuum heating furnace 110, the evacuation of the furnace is started. The sealant 104 used in this embodiment has a softening point of approximately 420° C. to 440° C. and the melting start temperature is approximately 370° C. to 390° C. Around 350° C. to 370° C., which is immediately before the melting start, the gap 105 shown in FIG. 10, of the sealant 104 is still maintained. Thus, in this temperature range, it is possible to exhaust the impurity gas remaining in the space of the PDP 100 through this gap 105 from around the PDP 100, this temperature range being one which enables the impurity gas to be removed most efficiently. In view of this, the substrate temperature is temporarily maintained until the impurity gas is removed (period T2 in FIG. 12).

Next, the temperature is raised to around 400° C. to 410° C. (period T3 in FIG. 12) to soften the sealant 104. At this time, the viscosity of the sealant 104 is such that it starts to deform by the stress of the front glass substrate 101 and the back glass substrate 102 due to the clamping force of the clips 7 but that it does not deform without this stress. This deformation proceeds until the height of the sealant 104 becomes the same as that of the separator walls 20, and then the deformation stops.

Further, in the sealant 104, there exist minute bubbles which have been therein at the time of formation and temporary baking of the sealant material 104. When the periphery of the PDP 100 is evacuated to produce a low pressure state, there is a fear that these minute bubbles will become large bubbles as the viscosity of the sealant 104 is reduced. When such large bubbles exist, the sealant 104 cannot maintain the hermeticity of the discharge space 103 of the plasma display panel, and the reliability of the panel can deteriorate. In view of this, the pressure around the PDP is temporarily raised in the process of raising the temperature of the pair of substrates from 370° C. to 410° C. (period T3 in FIG. 12). By this operation, any minute bubbles are not allowed to become extremely large, and the reliability can be ensured.

This temporary rise in pressure can be effected by causing an inert gas such as Ar or discharge gas to leak into the vacuum heating furnace 110. At this time, there is an optimum value of the in-furnace pressure according to the balance with respect to the viscosity of the sealant 104.

When the temperature of the sealant is below the temperature of softening point of the sealant, the bubbles are not to occur even in the state of a pressure of several tens of kPa or more. Further in a case that the temperature of the sealant is around the temperature of beginning of sealant softening, that is, in the state of high viscosity, the bubbles are not to occur in the state of a pressure below several tens of Pa. The suitable pressure to prevent the bubbles form growing is depend on the temperature of the sealant.

As the temperature of softening point of the sealant in the embodiment is 420° C.˜440° C., the sealant is processed below 410° C. to avoid the bubble-occurence.

Usually, a pressure of several tens of kPa, which is somewhat lower than the atmospheric pressure, is applicable for practical use. Further, since the pressure rises as a result of de-gassing according to the temperature rise and time, the vacuum pump connected to the outlet 111 is controlled such that the in-furnace pressure of the vacuum heating furnace 110 is constantly kept low.

Further, to enhance the reliability in the hermeticity of the sealant 104, it is important to minimize the probability of existence of the minute bubbles in the temporarily baked sealant 104. For this purpose, apart from optimizing the de-binder-profile, etc. when temporarily baking the sealant 104, it is effective to perform de-bubble baking by high-temperature baking or baking atmosphere control in advance.

Next, to further soften the sealant 104, the temperature of the PDP 100 is maintained around 400° C. to 410° C. (period T4 in FIG. 12). This period T4 is the period necessary for the deformation of the sealant 104. In this embodiment, it is approximately several to several tens of minutes.

Next, the procedure advances to the step of cooling the PDP 100 (periods T5 to T6 in FIG. 12). The interior of the furnace is exhausted again at a temperature of around 350° C. to 400° C., at which the sealant 104 cures, and the temperature is reduced to room temperature while maintaining the high vacuum.

Next, the ascent/descent type seal head 112 is attached so as to cover the through-hole 115 and the shaped glass frit 119.

The construction of this ascent/descent type seal head 112 will be described with reference to FIG. 11. At the portion where the ascent/descent type seal head 112 is in contact with the back glass substrate 102, there is provided a vacuum seal 114 to maintain the vacuum. Due to this vacuum seal 114, the ascent/descent type seal head 112 can be pressurized and brought into close contact with the back glass substrate 102, whereby the hermeticity of the vacuum heating furnace can be maintained. Further, this ascent/descent type seal head 112 is provided with an exhaust/gas-introduction piping 116 for exhausting and filling with discharge gas. A vacuum pump and cylinders of gases constituting discharge gas (not shown) with which to fill the discharge space 103 are connected to this exhaust/gas-introduction piping 116 by way of a switch valve. Further, this ascent/descent type seal head 112 is provided with a quartz glass window 118, through which infrared rays from an infrared irradiation lamp 117 can be applied to the shaped glass frit 119.

Until the vacuum seal 114 is brought into close contact with the back glass substrate 102, the interior of the discharge space 105 is temporarily exhausted preferably by way of the exhaust/gas-introduction piping 116, with this ascent/descent type seal head 112 being lowered. After this, this discharge space 105 is filled with a predetermined discharge gas. Next, infrared rays from the infrared irradiation lamp 117 is applied through the quartz glass window 118 to the shaped glass frit 119, which is formed of a material having a high infrared absorption rate, to thereby melt the shaped glass frit 119, thereby sealing the through-hole 115.

In the fifth embodiment, the sealant 104 is higher than the separator walls 20, and, when the glass substrates 101 and 102 are stacked together, a gap 105 is defined between the pair of substrates and the sealant 104, the impurities in this gap 105 being removed by exhausting the periphery of the pair of substrates before the melting of the sealant 104, so that the impurities adhering to or contained in the sealant 104 can be removed without allowing them to pass through the discharge space 103, whereby it is possible to prevent the discharge space 103 from being contaminated. Further, it is also possible to remove the impurities in the discharge space 103 before it is hermetically closed.

Further, a material having a high softening point is used for the sealant 104, and it is made possible to perform the removal of impurity gas before the fusing of the sealant 104 at a temperature as high as possible, whereby the removal of impurities can be effected more reliably, and it is possible to improve the operating characteristics of the plasma display panel.

Further, since it is possible to efficiently remove impurities, the exhaustion period at high temperature can be shortened. Further, in this embodiment, the exhaustion and the filling with discharge gas of the discharge space 103 are conducted without using any ducts, the conveyance, handling and installation of the PDP in the production process are facilitated.

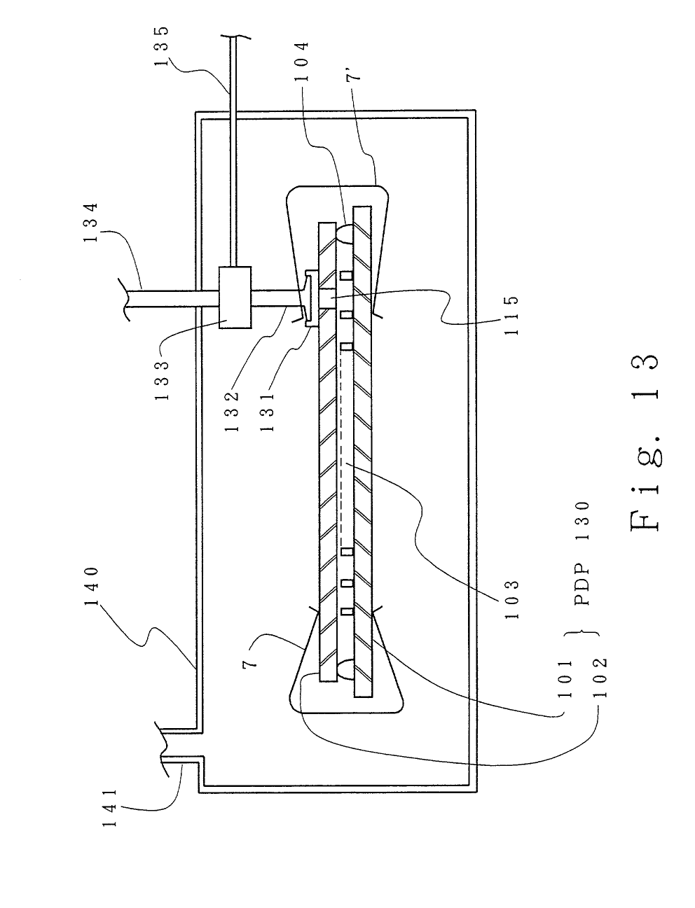

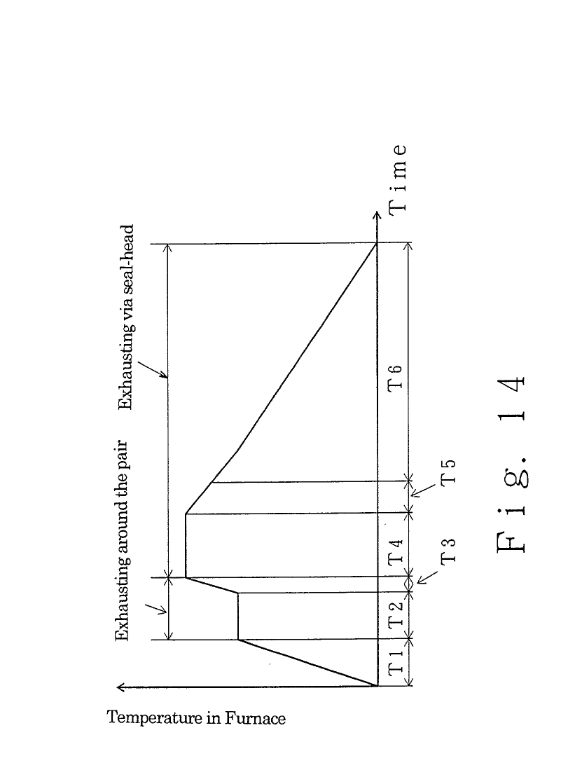

Next, FIGS. 13 and 14 show the sixth embodiment of the present invention. The sixth embodiment provides a method for mass production which is more easily realized in the form of a unit. FIG. 13 is a schematic diagram showing a processing of a PDP 130 including a pair of substrates 101 and 102, and FIG. 14 is a schematic diagram showing a processing cycle. The components having the same functions as those of the first through fifth embodiments are indicated by the same reference numerals and a description thereof will be omitted.

The front glass substrate 101 and the back glass substrate 102 are formed in the same manner as in the fifth embodiment. As in the fifth embodiment, the front glass substrate 101 and the back glass substrate 102 are stacked together, and are secured in position by a plurality of clips 7. The clamping positions for the clips 7 are the same as those of the fifth embodiment.

The vacuum heating furnace 140 used is heated by a heater (not shown) and the interior of the furnace is evacuated by a vacuum pump (not shown) connected through an outlet 141, creating a high vacuum state in the furnace 140.

Next, a shaped glass frit 131 and a flared duct 132 are secured in position by a clip 7′. The tip-shape of the clip 7′ is like a U-shaped which enable the clip 7′ to secure the flared duct 132 on the back glass substrate 102 with pressing the flared part of the duct 132. A seal head 133 is attached to the non-flared end of the duct 132. The material of a part in seal head 133 is a resin which makes it possible to maintain the vacuum by bringing it into press contact so as to tighten the duct 132 from around. The heat resistance of this resin is approximately 200° C., and, to cool the entire resin, the seal head 133 is provided with a cooling water piping 135 for circulating cooling water.

Further, a through-hole 115 of the back glass substrate 102 is connected to an exhaustion/gas-introduction piping 134 through the duct 132. This exhaustion/gas-introduction piping 134 is connected to a vacuum equipment and a discharge gas supplying equipment through a switching valve (not shown).

The temperature of the pair of substrates put in the vacuum heating furnace 140 is raised to approximately 350° C., at which the change in the substrate performance due to impurity gases do not easily occur, at a rapid temperature rise rate such that the substrates do not suffer breakage (T1 in FIG. 14).

Next, the entire periphery of the pair of substrates stacked together is evacuated, and maintained at approximately 350° C. to 370° C. (T2 in FIG. 14).

At this time, the sealant 104 is not melted yet, so that, as in the fifth embodiment, the impurity gas generated from the substrates can be efficiently removed from the gap 105 (See FIG. 10) between the sealant 104 and the front glass substrate 101. The temperature of the substrates is maintained until the removal of this impurity gas is completed.

Next, the temperature of the substrates stacked together is raised to 370° C. to 410° C. (T3 in FIG. 14). At this time, as in the fifth embodiment, the melting and fusion of the sealant 104 are sequentially effected. At the same time, the melting of the shaped glass frit 131 and the fusion of the flared portion of the duct 132 to the back glass substrate 102 are sequentially effected. When the fusion by the sealant 104 and the shaped glass frit 131 is completed, the discharge space 103 formed by the pair of substrates stacked together and the duct 132 become a closed system with respect to the exhaustion/gas-introduction piping 134 through the seal head 133, and evacuation is possible through the seal head 133.

Here, the pressure in the discharge space 103, which has become a closed system, is controlled to be a negative pressure with respect to the pressure in the vacuum heating furnace 140, and the in-furnace pressure is set to be constantly pressurizing with respect to the substrates, the deformation of the molten sealant 104 being performed by utilizing this pressurizing force.

Thus, unlike the fifth embodiment, the clamping force of the clips 7 for clamping and fixing the substrates stacked together can be weakened such that the positional deviation of the front glass substrate 101 and the back glass substrate 102 does not occur or the number of clips can be reduced. Further, the periphery of the substrates stacked together is restored to the atmospheric level until the sealant 104 is completely melted.

By this operation, it is possible, as in the fifth embodiment, to cope with the problem due to the growth of the minute bubbles existing in the sealant 104. In the sixth embodiment, in the condition in which the substrates stacked together form a closed system, the interior thereof is not contaminated by impurity gas, so that it is possible to use the atmospheric gas as the leak gas to restore the pressure in the furnace to the atmospheric pressure. Further, the inert gas of high purity and the discharge gas can be processed in the very small amount with which the interior of the substrates stacked together is filled. Further, the processing after the leakage to the atmosphere (T4 through T6 in FIG. 14) can be conducted in the atmospheric-air heating furnace as in the conventional process.

Next, the exhaustion of the interior of the substrates stacked together is continued, and maintained for a fixed period (T4 in FIG. 14) so that there is no remnant of the impurity gas; since most of the impurity gas generated from the substrates is removed by evacuation from the periphery before the fusion of the glass material 104, it is possible to advance to the temperature lowering process (T5 in FIG. 14) in a shorter time than in the conventional method.

Further, leakage of impurity gas, etc. in the interior of the stacked substrates by way of the vacuum heating furnace 140 is not effected as in the fourth embodiment, so that there is no problem due to contamination of the inert gas, which is advantageous from the viewpoint of yield.

Next, as in the fifth embodiment, the temperature is lowered until the temperature in the interior of the substrates stacked together is room temperature (T6 in FIG. 14), and the filling with discharge gas is conducted through the seal head 133 and the duct 132. Then, the duct 211 is cut away to thereby complete the panel.

In the sixth embodiment, the glass substrates can be held by a weak clamping force, and it is possible to sufficiently remove the impurities in the discharge space 103. Further, it is possible to limit the application of the vacuum heating furnace, which is a large-scale equipment, to a very limited period (T2 through T3 in FIG. 14) of approximately 350° C. to 410° C. Further, the sealing of the through-hole 115 can be effected by the same method as the conventional one, so that a relatively simple equipment suffices, and, further, an improvement can be achieved in terms of reliability.

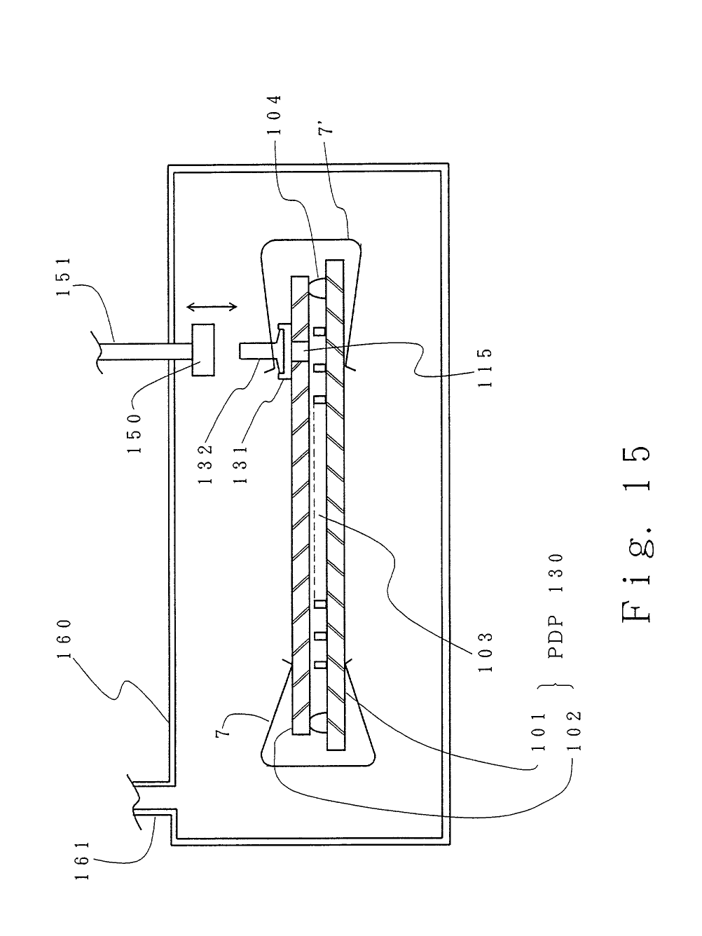

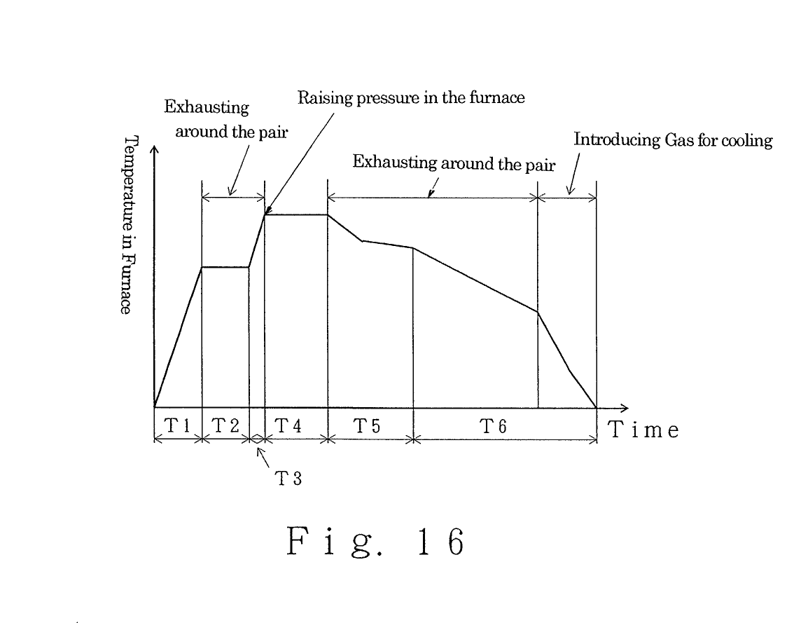

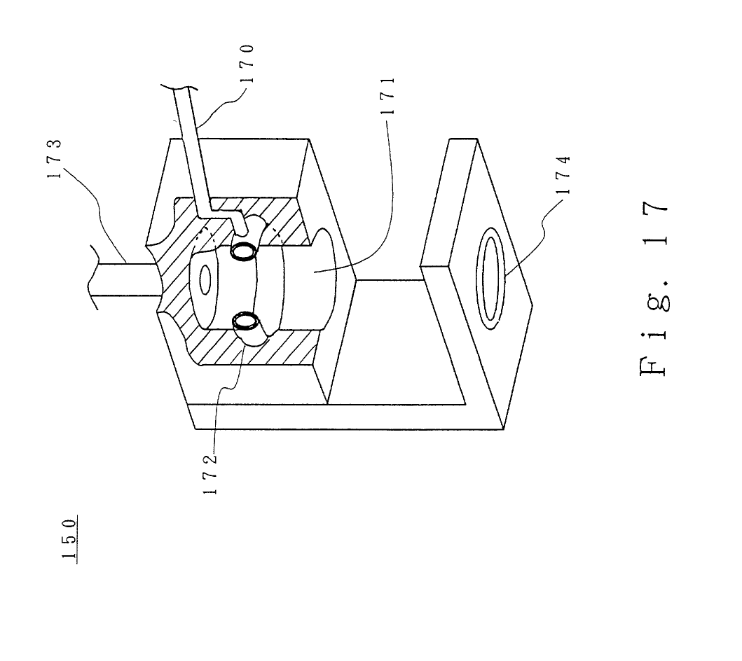

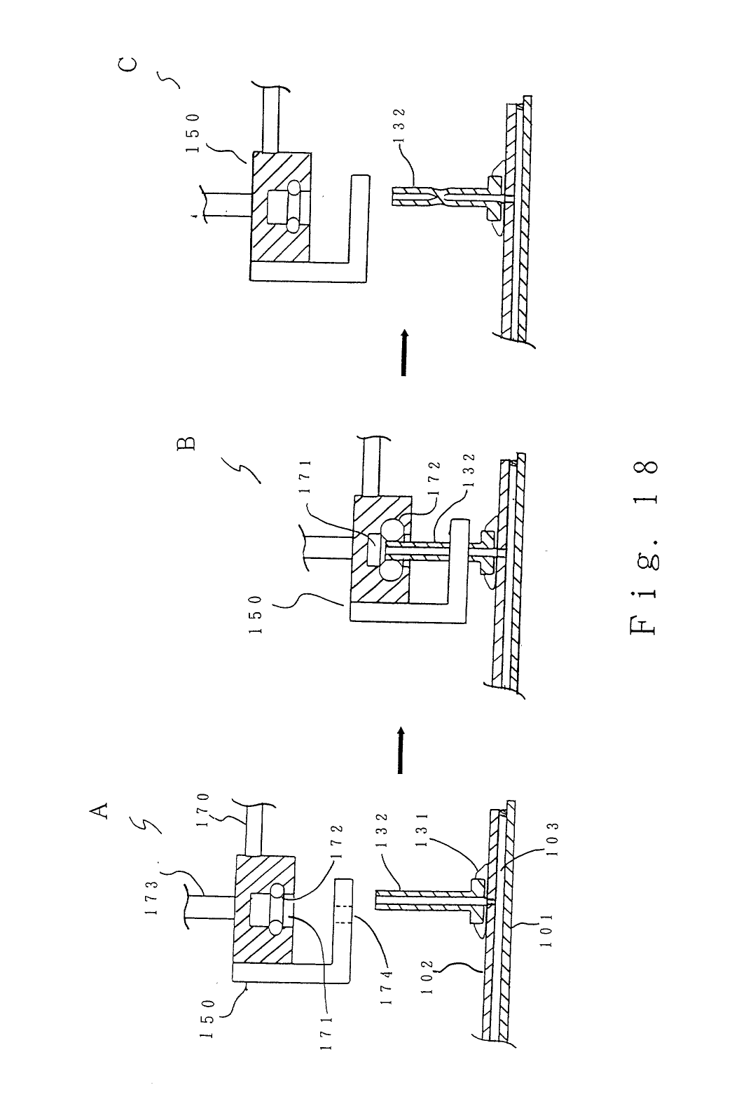

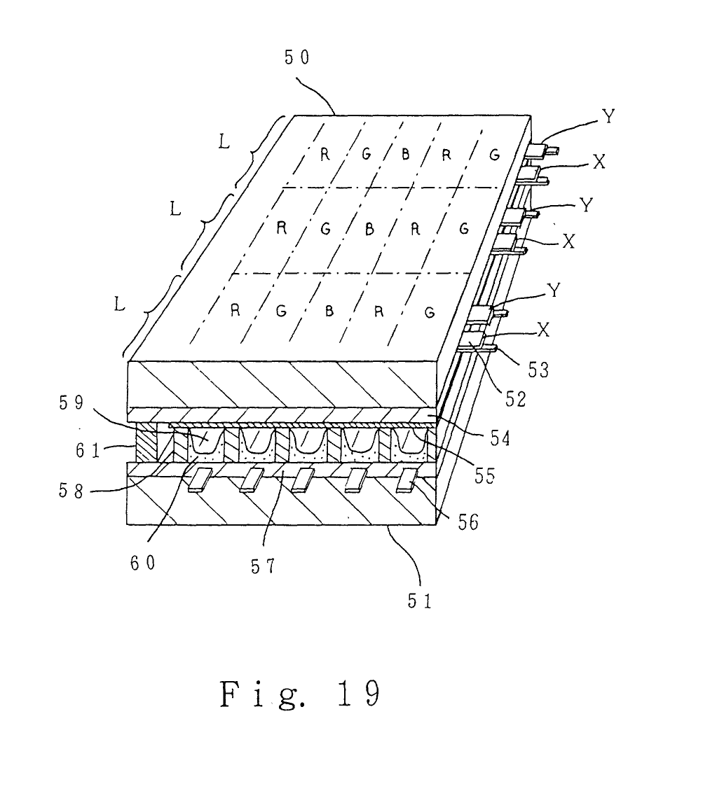

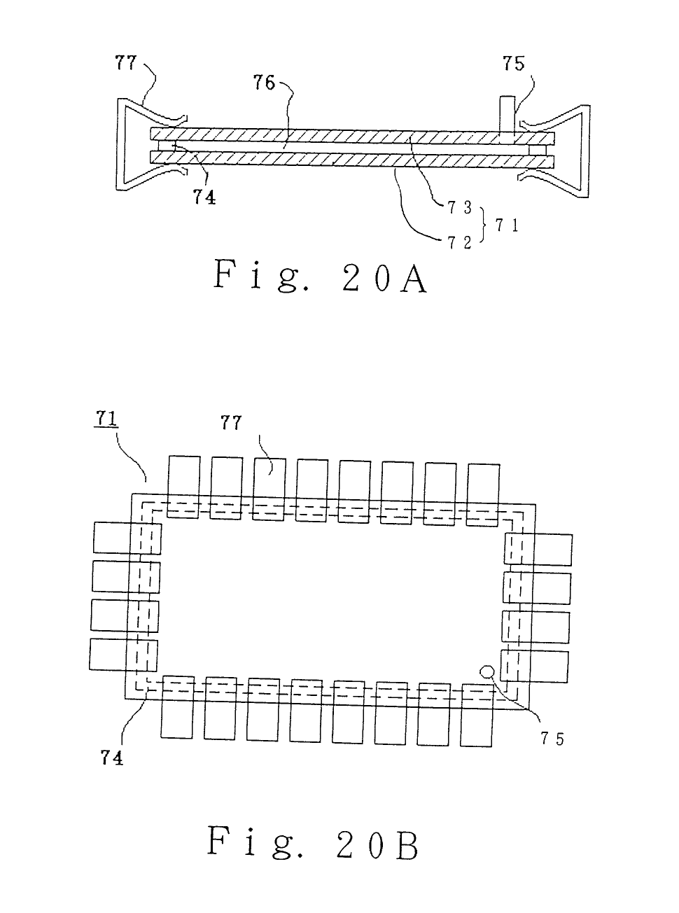

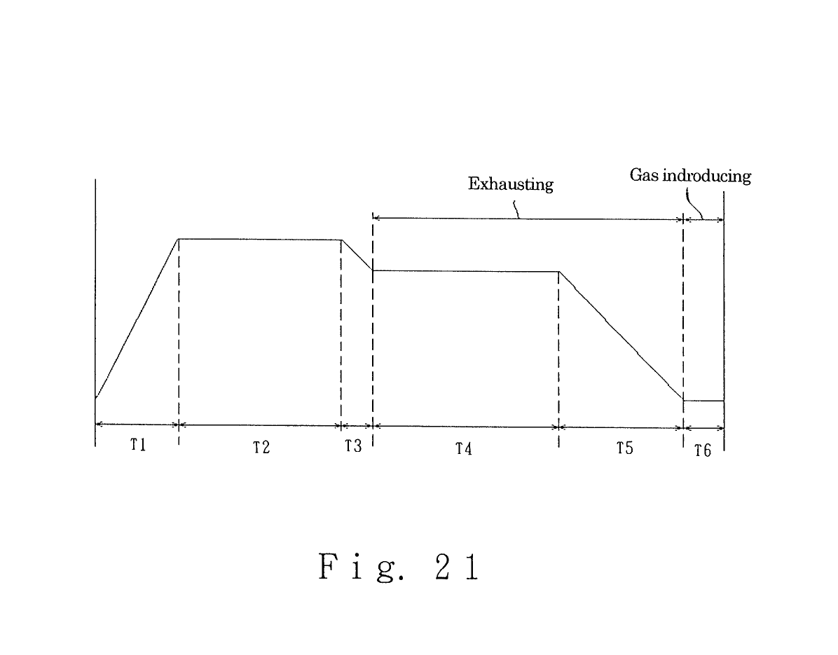

Next, FIGS. 15 through 18 show the seventh embodiment. In this embodiment, the PDP 130 used in the sixth embodiment is used. FIG. 15 illustrates the processing of the PDP 130 including the pair of substrates 101 and 102, and FIG. 16 shows the processing cycle. FIG. 17 shows the seal head in detail, and FIG. 18 shows the operation of this seal head. The components which have the same functions as those of the first through sixth embodiments are indicated by the same reference numerals, and a description thereof will be omitted.

In the seventh embodiment, there is no need to constantly keep the seal head 150 attached to the duct 132 as in the sixth embodiment, and the periphery of the pair of substrates is to be held in high vacuum only during the necessary period as in the sixth embodiment.

The front glass substrate 101 and the back glass substrate 102 are formed as in the fifth embodiment. As in the fifth embodiment, the front glass substrate 101 and the back glass substrate 102 are stacked together and secured in position by a plurality of clips 7. The clamping positions of the clips 7 are also the same as in the fifth embodiment.

Next, as in the sixth embodiment, the shaped glass frit 131 and the flared duct 132 are secured in position by a clip 7′. Unlike the sixth embodiment, the non-flared end of the duct 132 is open.

Next, the pair of substrates stacked together is put in the vacuum heating furnace 160, and the temperature is raised (T1 in FIG. 16). To approximately 350° C., at which the exhaust of impurity gas and the change in the substrate performance do not easily occur, the temperature is raised at a rapid rate such that the substrates do not suffer breakage.

Next, the entire periphery of the substrates stacked together is evacuated. The temperature of the substrates stacked together is maintained at approximately 350° C. to 370° C. (T2 in FIG. 16).

At this time, the seal glass 104 is not melted yet, so that, as in the fourth and fifth embodiments, the impurity gas generated from the front and back glass substrates 101 and 102, etc. can be efficiently removed. The substrate temperature is maintained until the removal of the impurity gas is completed (T2 in FIG. 16).

Next, the temperature of the substrates stacked together is raised to 370° C. to 410° C. (T3 in FIG. 16). At this time, as in the second embodiment, the melting and fusion of the sealant 104 is sequentially effected. At the same time, the melting of the shaped glass frit 131 and the fusion of the back glass substrate 102 and the flared portion of the duct 132 are also sequentially effected.

Next, as in the fifth embodiment, until the sealant 104 is completely melted, the pressure in the periphery of the substrates stacked together is raised with inert gas or discharge gas introduced through the exhaustion/gas-introduction piping 151, whereby, as in the fourth and fifth embodiments, it is possible to cope with the problem due to the growth of the minute bubbles existing in the sealant 104.

Next, the temperature is lowered to a temperature at which the sealant 104 is cured (T5 in FIG. 16), and the exhaust from the periphery of the substrates stacked together is started again. By this exhaustion, the minute amount of impurity gas generated during the period T4 in FIG. 16 is more reliably removed. Further, as needed, the temperature is kept constant in T5 of FIG. 16 to thereby remove the impurity gas more reliably.

Next, cooling is effected (T6 in FIG. 16). To improve the cooling efficiency, it is possible to fill the vacuum heating furnace 160 with discharge gas containing no impurity gas, etc. through the exhaustion/gas-introduction piping 151.

Next, after the temperature is lowered until the temperature of the substrates stacked together is room temperature, the seal head 150 is lowered by an ascent/descent mechanism (not shown), and attached to the duct 132. This seal head 150 will be described in detail with reference to FIGS. 17 and 18.

To the air piping 170 for driving the seal head 150, high-pressure air is supplied from an air supply source (not shown) through a valve. This high-pressure air is supplied to an O-ring 172 provided on the side wall of a cylindrical portion 171, making it possible to make the inner diameter of the O-ring 172 variable. Further, on the top wall of the cylindrical portion 171, there is provided an exhaustion/gas-introduction piping 173. At the L-shaped forward end in the lower portion of the seal head 150, there is provided a heater 174 for fusing and sealing a part of the duct 132.

Next, the operation of the seal head will be described with reference to FIG. 18. “A” in FIG. 18 shows the condition before the seal head 150 is lowered, “B” in FIG. 18 shows the condition in which the seal head 150 is attached to the duct 132, and “C” in FIG. 18 shows the condition in which the seal head 150 is restored to the position of FIG. A after the discharge space is filled with a predetermined gas through the seal head 150 and further the duct 132 is sealed by the heater 174.

When this seal head 150 is at the lowered position, air is supplied to the O-ring 172, and the inner portion of the O-ring 172 is brought into close contact with the duct 132 (B in FIG. 18). Due to this close contact, the discharge space 103 is connected to the exhaustion/gas-introduction piping 173 through the cylindrical portion 171. Next, the gas introduced at the time of cooling is exhausted by a vacuum pump (not shown) connected to the duct 173, and then the discharge space is filled with discharge gas by way of the exhaustion/gas-introduction piping 173, the seal head 150 and the conduction pipe 132 until a predetermined pressure is reached. Here, when the discharge gas is used as the cooling gas, only the filling pressure of the discharge gas is adjusted.

After this filling, electricity is supplied to the heater 174, and a part of the conduction pipe 132 is fused and sealed, the seal head 150 being raised (C in FIG. 18).

In this embodiment, in addition to the impurity removing effect of the fifth and sixth embodiments, there is no need to constantly keep the seal head 133 attached to the conduction pipe 132 as in the fifth embodiment, so that the conveyance of the substrates stacked together, etc. are facilitated. Further, since the seal head is used only at a temperature around room temperature, it is possible to prevent the generation of impurity gas from the seal head. Further, there is no need to use a temperature resistant member, so that a relatively simple equipment suffices, and an improvement is achieved in terms of reliability.

In accordance with the plasma display panel manufacturing method of the present invention, the sealant is melted, with the pressure between the pair of substrates being reduced, so that the sealing is effected as the pair of substrates are drawn to each other while crushing the sealant due to the difference between the inner and outer pressures. Thus, there is no need to apply pressure to the substrates from outside, and the sealing is possible without involving any stress. Further, it is possible to substantially shorten the time needed for sealing the pair of substrates by the sealant. Further, the installation time for the jig for applying pressure from outside is shortened, thereby achieving an improvement in terms of mass productivity.

Further, when a plurality of PDPs are obtained from a single substrate, the sealant is arranged in the central portion of the substrate. The sealing of this central portion can also be reliably effected without using any jig.

Further, in accordance with the present invention, the impurities in the discharge space are removed through the gap between the sealant and the substrates, so that the impurities in the discharge space can be removed more reliably, and it is possible to reduce the probability of the impurities from the sealant entering the discharge space, whereby it is possible to improve the operating characteristics and the display characteristics of the plasma display panel.

While various embodiments of the present invention have been shown and described, it should be understood that other modifications, substitutions and alternatives may be apparent to one of ordinary skill in the art. Such modifications, substitions and alternatives can be made without departing from the spirit and scope of the invention, which should be determined from the appended claims.

Various features of the invention are set forth in the appended claims.

What is claimed is:

1. A manufacturing method of a gas discharge panel having a discharge space in between a pair of substrates sealed together with a sealant, comprising sequentially the steps of:
a first step to form the sealant in a frame-shape on at least one of the substrate, and to stack said substrate onto another substrate via the sealant;
a second step to lower a pressure in a space existing between the pair of substrates by exhausting the space and within the sealant, while the sealant is melt by being heated;
a third step to solidify the sealant so as to fix the pair of the substrates as well to form a predetermined discharge space;
a fourth step to remove an impurity in the discharge space; and
a fifth step to fill a discharge gas into the discharge space.

2. A manufacturing method of a gas discharge panel as recited in claim 1, wherein in the second step an exhausting of the space is begun when the sealant reaches a predetermined melting temperature thereof, and the sealant is pressed by holding a predetermined low pressure in the space so as to define a gap between the pair of the substrates.

3. The manufacturing method of a gas discharge panel as recited in claim 1, wherein a exhausting process for lowering a pressure in a space in between the substrates and a heating process for melting the sealant are begun simultaneously

4. A manufacturing method of a gas discharge panel as recited in either one of claim 1 to claim 3, wherein in the second step are provided separator walls for defining the discharge space on at least one of the substrates so that said separator walls define said gap of the space when the pair of substrates press the sealant.

5. A manufacturing method of a gas discharge panel as recited in either one of claim 1 to claim 4, wherein a non-continuous barrier wall is provided beforehand in a vicinity of inside the sealant so as to prevent an inward invasion of the sealant melted.

6. A manufacturing method of a gas discharge panel as recited in either one of claim 1 to claim 5, wherein in said first step said frame-shaped sealant is formed of a plurality of frames thereof on said one of substrates; and
said steps 2 to 5 are carried out for said frames and for a plurality of spaces formed with said frames.

7. A manufacturing method of a gas discharge panel as recited in claim 6, wherein each of said spaces formed of said sealant frame is provided with a through hole in the vicinity where each of portions of adjacent said spaces gathers; so that said exhausting and said discharge gas filling process are carried out via a pipe connected commonly to each through hole.

8. A manufacturing method of a gas discharge panel as recited in either one of claim 1 to claim 7, wherein in said first step peripheral portions of said pair of substrates are pinched with tentatively fixing clips.

9. A manufacturing method of a gas discharge panel having a discharge space in between a pair of substrates sealed together with of a sealant, comprising sequentially the steps of:
a first step to form a plurality of the sealant each in a shape of frame at least on a surface of a substrate opposing to another substrate, and to stack said substrate onto another substrate via a plurality of the sealant, wherein each of the substrates is formed of parts for composing the panels within each of reigns which are defined by a plurality of cutting lines, and each of the shapes formed with the sealant is formed so as to enclose a corresponding reign;
a second step to lower each of pressures in a plurality of spaces formed in between the pair of substrates due to the existence of the plurality of sealant so as to press over the surfaces of the pair of the substrates and to fix a gap between the pair of the substrates while the plurality of sealant is melt by being heated;
a third step to solidify the plurality of the sealant once being melted so as to fix the pair of the substrates as well to form the discharge spaces in between the pair of substrates;
a fourth step to remove an impurity in the discharge spaces;
a fifth step to fill a discharge gas into the discharge spaces; and
a sixth step to cut the pair of the substrates along the cutting lines into a plurality of smaller substrates so as to form a plurality of smaller discharge panels.

10. The manufacturing method of a gas discharge panel as recited in 9, wherein each of said spaces formed of said sealant frame is provided with a conduction pipe in a portion, said portions each are in a vicinity and in each of adjacent spce each other, so that said exhausting and said discharge gas filling process are carried out via a pipe connected commonly to each the conduction pipe.

11. A manufacturing method of gas discharge panel provided with a sealed pair of substrates opposing to each other, one of the substrates having a plurality of electrodes on a inner surface thereof so as to produce a discharge with adjacent electrodes, and the another of the substrates having on an inner surface thereof fluorescent materials of a plurality of color kinds for emitting fluorescences stimulated by the discharge and a plurality of separator walls formed of in predetermined pattern so as to separate said fluorescent materials, comprising of a step:
a step for sealing said pair of the substrates, wherein said step includes a first process to form a sealant at a periphery of the other substrate higher than that of said separator walls, a second process to exhaust a gap in between the pair of the substrates opposing each other till a beginning of said sealant melting, and in turn a third process to heat said sealant till said sealant to be melt while the gap is hold in low-pressure therein by said exhausting.

12. A manufacturing method of a gas discharge panel having a pair of substrates sealed at a periphery thereof, said pair of substrates having a plurality of electrodes on each substrates and opposing to each other via a predetermined discharge space therebetween, comprising the steps of:
a first step to exhaust said discharge space via a leak-clearance between a seal-glass layer and the substrate while an inner space of the furnace is kept at predetermined temperature, wherein said seal-glass layer is formed on a periphery of one of the substrates, said each of the substrates being kept at predetermined interval therebetween is held in a vacuum-heating furnace;
a second step to seal said pair of the substrates during lowering a pressure in an opposition-space in between the pair of the substrates via a conduction pipe connected to a through hole previously provided in a portion of another substrate while the temperature in the inner of the furnace raises to a melting temperature of said seal-glass layer.

13. The manufacturing method of a gas discharge panel as recited in claim 12, wherein a pressure around said pair of the substrates is raised once at least in process of said lowering a pressure around the pair of the substrates before melting of said seal-glass layer.

14. The manufacturing method of a gas discharge panel as recited in claim 12, wherein said lowering the pressure via a seal-head connected to the conduction pipe.

15. A manufacturing method of a gas discharge panel, said panel having a sealant and a plurality of separator walls so as to keep a discharge space on at least one of a pair of substrates and the pair of the substrates being sealed by the sealant, comprising sequentially steps of:
a first step to form a frame-shape sealant on one at least of the substrates, and to stack the substrate onto another substrate;
a second step to arrange a formed-glass-frit in a vicinity of a through hole provided to one at least of the substrates;
a third step to heat the pair of the substrates so as to raise a temperature of the pair of the substrates by heating, and to exhaust a gas and lower a pressure around the pair of the substrates so as to remove a impurity in a space in between the substrates;
a fourth step to melt the sealant;
a fifth step to form said discharge space in a height determined by that of the separator walls due to deforming the sealant;
a sixth step to cool the pair of the substrates so as to solidify the sealant;
a seventh step to fill the space with a discharge gas;
a eighth step to seal the through hole used for filling the discharge gas into the discharge space.

16. The manufacturing method of a gas discharge panel as recited in claim 15, wherein in the first step a height of the sealant is formed higher than that of the separator walls, clips for pinching and fixing said the pair of the substrates are located so as to press portions within a vicinity of regions where the separator walls, and the discharge space is formed via each step from the first to fifth steps being carried out while the sealant is applied with a force due to bending of the substrates.

17. The manufacturing method of a gas discharge panel as recited in claim 15, wherein in the fifth step is caused a force toward the discharge space from an exterior around the pair of the substrates due to a pressure around the pair of the substrates being kept higher than that in the discharge space.

18. The manufacturing method of a gas discharge panel as recited in claim 15, wherein in the fifth step is closed a portion in a conduction path from the discharge space to the exterior of the pair of the substrates so as to provide a uniform pressure-difference between the pressure in the discharge space and that in the exterior of the pair of the substrates.

19. The manufacturing method of a gas discharge panel as recited in claim 15, wherein in the third step an exhausting of an exterior around the pair of the substrates is begun when the sealant reaches a vicinity of temperature at which a degassing becomes active and is ended when the sealant sticks to the substrate.

20. The manufacturing method of a gas discharge panel as recited in claim 15, wherein a conduction pipe is connected to the through hole, and a seal-head available to exhaust the discharge space via the conduction pipe is connected to the conduction, and an exhausting the discharge space is carried out via the conduction pipe and the seal-head after the sealant sticking to the substrate.

21. The manufacturing method of a gas discharge panel as recited in claim 15, wherein in the fourth step the pressure around the pair of the substrate is raised to a level of pressure at which a bubble existing in a sealant does not grow bigger.

22. The manufacturing method of a gas discharge panel as recited in claim 20, wherein after the pressure around the pair of the substrate is raised to a level of pressure at which a bubble existing in a sealant does not grow bigger.

23. The manufacturing method of a gas discharge display panel as recited in 15, wherein in the fourth step the sealant is melted in a temperature below a beginning of softening of the sealant so as to prevent a bubble in the sealant form growing.

24. The manufacturing method of a gas discharge display panel as recited in 15, wherein a conduction pipe is bonnected to the through-hole, and a seal head available to exhaust the discharge space is connected to the conduction pipe after the sealant is dolidified and cooled so as to introduce a discharge gas into the discharge space.

25. The manufacturing method of a gas discharge display panel as recited in 20, wherein the seal-head having a heater to heat the conduction pipe melts a part of the conduction pipe by heating after introducing of the discharge gas into the discharge space via the conduction pipe so as to seal the discharge space.

26. The manufacturing method of a gas discharge display panel as recited in 25, wherein a pressure in a ambient of the pair of the substrates or the part of the conduction pipe to be melt is raised to a higher pressure than that in the discharge space when the part of the conduction pipe is melt.
